(19) United States
(12) Patent Application Publication
(10) Pub. No.: US 2016/0229525 A1
(43) Pub. Date: Aug. 11, 2016

(54) ELECTROMECHANICAL ROTARY ACTUATOR

(71) Applicant: HAMILTON SUNDSTRAND CORPORATION, Windsor Locks, CT (US)

(72) Inventors: Nicholas R. Van De Veire, Tempe, AZ (US); Derick S. Balsiger, Mayer, AZ (US)

(21) Appl. No.: 14/482,004

(22) Filed: Sep. 10, 2014

(51) Int. Cl. B64C 13/50; H02K 7/116; B64C 9/00

(52) U.S. Cl. CPC B64C 13/50; B64C 9/00; H02K 7/116; B64C 2009/005

(57) ABSTRACT

An electromechanical hinge-line rotary actuator is provided. The actuator includes a drive member and a motor disposed inside and directly coupled to the drive member. The motor has a rotor configured toward an outside of the motor and directly coupled to an input of the drive member and a stator configured toward an inside of the motor and positioned inside the rotor. The drive member, rotor, and stator are arranged concentrically with each other.

### BACKGROUND OF INVENTION

This invention relates, generally, to an actuator and, more specifically, to an electromechanical hinge-line rotary actuator for use with a thin-wing aircraft in flight-control applications.

Many systems require actuators to manipulate various components. Rotary actuators rotate an element about an axis. In flight-control applications, there has been a trend toward a thinner wing such that size and space are limited at a point of attachment between the wing and an aileron (a wing-control surface) of an aircraft.

This trend has driven use of a rotary actuator of a “hinge-line” design, wherein a rotational axis of the actuator is aligned with that of the aileron and the actuator acts as a hinge (hence, the term “hinge-line”). This trend also raises a need for such an actuator with a tighter cross-section, which limits the diameter of a motor of the actuator, and higher power density.

In turn, torque of the motor is directly related to the motor diameter and current flowing through windings of the motor. However, with the limited motor diameter and an amount of the current being limited to useable amounts on a power bus of the aircraft, an amount of such torque is limited as well. And, since power of the motor equates to speed thereof times the torque amount and this amount is limited, the speed must be higher. Yet, use of the higher-speed motor at the limited torque amount is driving use of higher gear ratios, which makes inertia of the motor a sensitive design parameter.

More specifically, reflected inertia comes into play whenever the motor or a gear set of the aircraft is trying to be back-driven, which is a requirement for a surface of the aileron. And, reduction in the inertia prior to a gear affects the reflected inertia by a factor of a gear ratio squared (for example, a “10:1” gear ratio yields a reflected inertia of 100 times greater than the motor inertia while a “100:1” gear ratio yields a reflected inertia of 10,000 times greater). The inertia also affects responsiveness of the aircraft—i.e., a higher level of the inertia results in a lower responsiveness.

A typical electromechanical hinge-line rotary actuator designed for flight-control applications is arranged to use a conventional motor that is framed (i.e., encased, housed, or mounted) and includes a rotor. The rotor is disposed inside the frame and indirectly connected to an end of a planetary gearbox or gear set through a drive shaft or coupler. In this way, the motor is disposed exterior to and in alignment with the gear set, and there are bearings for the motor and gear set. Such alignment is accomplished by a precision-machined housing for the motor and gear set or compliant coupling on an output shaft of the motor to an input of the gear set. This arrangement has inefficiencies associated with packaging and is not optimized for typical requirements of such an actuator. More specifically, it is not optimized for power density, performance, and reliability.

Accordingly, it is desirable to provide an electromechanical hinge-line rotary actuator an arrangement of which does not have inefficiencies associated with packaging and is optimized for typical requirements of such an actuator in flight-control applications. More specifically, it is desirable to provide such an actuator that reduces inertia and is optimized for power density, performance, and reliability.

### BRIEF DESCRIPTION OF INVENTION

According to a non-limiting exemplary embodiment of the invention, an electromechanical rotary actuator is provided. The actuator includes a drive member and a motor disposed inside and directly coupled to the drive member. The motor has a rotor configured toward an outside of the motor and directly coupled to an input of the drive member and a stator configured toward an inside of the motor and positioned inside the rotor. The drive member, rotor, and stator are arranged concentrically with each other.

The actuator is configured to be employed with a thin-wing aircraft. Toward that end, arrangement of the actuator does not have inefficiencies associated with packaging and is optimized for typical requirements of such an actuator in flight-control applications—power density, performance, and reliability. More specifically, the concentric packaging of components [i.e., the drive member and motor (stator and rotor)] of the actuator provides a higher power density. Also, a load path of the actuator is a direct drive such that a drive shaft is not required, resulting in a lower inertia and, in turn, higher performance. Furthermore, the actuator has few components (including removal of one set of bearings and no requirement as well for the compliant coupling or precision-machined housing), which lends itself to higher reliability and reduced cost. In addition, a total axial stack length of the actuator can be changed to accommodate a higher output load, making the actuator versatile for different applications. Moreover, the actuator can achieve higher forces while it maintains a same cross-section thereof, making the actuator versatile for the different applications.

### BRIEF DESCRIPTION OF DRAWING

The subject matter that is regarded as the invention is particularly pointed out and distinctly claimed in the claims at the conclusion of the specification. The foregoing and other features and advantages of the invention are apparent from the following detailed description taken in conjunction with the accompanying drawing in which:

FIG. 1 is an end view of a non-limiting exemplary embodiment of a wing of an aircraft provided with an electromechanical hinge-line rotary actuator according to the invention.

FIG. 2 is a schematic top view of a non-limiting exemplary embodiment of the electromechanical hinge-line rotary actuator according to the invention.

FIG. 3 is a schematic side environmental view of the embodiment of the electromechanical hinge-line rotary actuator illustrated in FIG. 2.

FIG. 4 is a schematic sectional side view of the embodiment of the electromechanical hinge-line rotary actuator illustrated in FIG. 2.

### DETAILED DESCRIPTION OF INVENTION

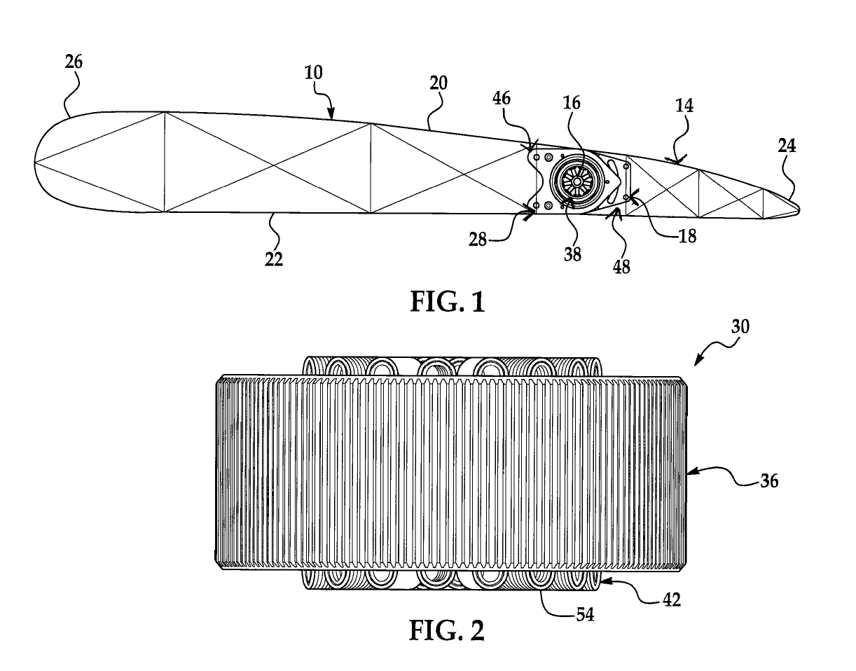

Referring now to FIG. 1, a non-limiting exemplary embodiment of a wing of an aircraft (not shown) is generally indicated at 10. Although the wing 10 is disclosed herein as being implemented with a non-rotary-wing aircraft, such as an airplane, it should be appreciated that the wing 10 can be implemented with any suitable type of aircraft, in general, and non-rotary-wing or rotary-wing aircraft (such as a helicopter), in particular.

As shown in FIG. 1, the wing 10 is one of two substantially similar wings of a lift system of the aircraft (in contrast, a rotor blade would be one of a plurality of substantially similar rotor blades of a rotor system of a helicopter). The wing 10 defines a root portion (not shown) that extends to tip portion (not shown) through an aileron portion, generally indicated at 14, which acts as a flight-control or an output-control surface (such as a wing flap). The aileron portion 14 also defines, in turn, an axis of motion or rotation 16 and includes a spar, generally indicated at 18. The wing 10 defines further first and second opposing surfaces 20, 22, a trailing edge 24, and an opposing, leading edge 26 and includes a rearward spar, generally indicated at 28.

The wing 10 includes also a control system (not shown) that has an electromechanical hinge-line rotary actuator, generally indicated at 30, and a controller (not shown). The actuator 30 defines the axis of rotation 16. The controller may be mounted to or near the actuator 30 and is operatively linked to the actuator 30 and a control system (not shown).

A stationary attachment bracket or ground arm, generally indicated at 46, of the actuator 30 is mounted to the wing rearward spar 28 and configured to be attached to interior structure of the wing 10. A rotatable attachment bracket or an output arm, generally indicated at 48, of the actuator 30 is mounted to a frame of or within an interior of the aileron portion 14. The mounting is highly flexible as long as the axis of rotation 16 of the aileron portion 14 is aligned with an axis of rotation 16 of the actuator 30. The actuator 30 allows wing flexing and, hence, does not put undue stress on the wing 10 at points of attachment when flex is encountered, such as during turbulence.

It should be appreciated that the control system can also define a plurality of control surfaces (not shown) arranged within the aileron portion 14 and selectively deployed between the first and second surfaces 20, 22 to affect flight dynamics of the wing 10. Each surface defines first and second surface portions. The actuator 30 is configured to rotate the surface from a first or neutral position, such that the surface is disposed within the wing 10, to a second or deployed position, such that the surface extends out an outer periphery of the wing 10. At this point, it should be appreciated that the above description is provided for the sake of completeness and to enable a better understanding of one non-limiting exemplary application of the actuator 30.

Referring now to FIGS. 2-4, a non-limiting exemplary embodiment of the actuator 30 is shown. The actuator 30 is disclosed herein as being implemented with a control system for a flight-control application. However, it should be appreciated that the actuator 30 can be implemented in any suitable system capable of operating in multiple environments and should not be considered as being limited to non-rotary or rotary aircraft or aircraft of any kind.

The actuator 30 includes, in general, a drive member, generally indicated at 36, a motor, generally indicated at 38 (FIG. 1), disposed inside and directly coupled to the drive member 36. The motor 38 includes a rotor, generally indicated at 52, configured toward an outside of the motor 38 and directly coupled to an input (not shown) of the drive member 36 and a stator, generally indicated at 42, configured toward an inside of the motor 38 and positioned inside the rotor 52. The drive member 36, rotor 52, and stator 42 are arranged substantially concentrically with each other.

More specifically, the rotor 52 and stator 42 combine with each other to make up the motor 38. The actuator 30 defines a longitudinal axis and includes also the ground arm 46 that is configured to be connected to the wing rearward spar 28. The actuator 30 includes also the output arm 48 that extends from the drive member 36. In flight-control applications, the output arm 48 can define a hole 50 configured to receive a pin (not shown) that, in turn, is configured to be connected to an output-control surface (i.e., the aileron spar 18) of the aircraft.

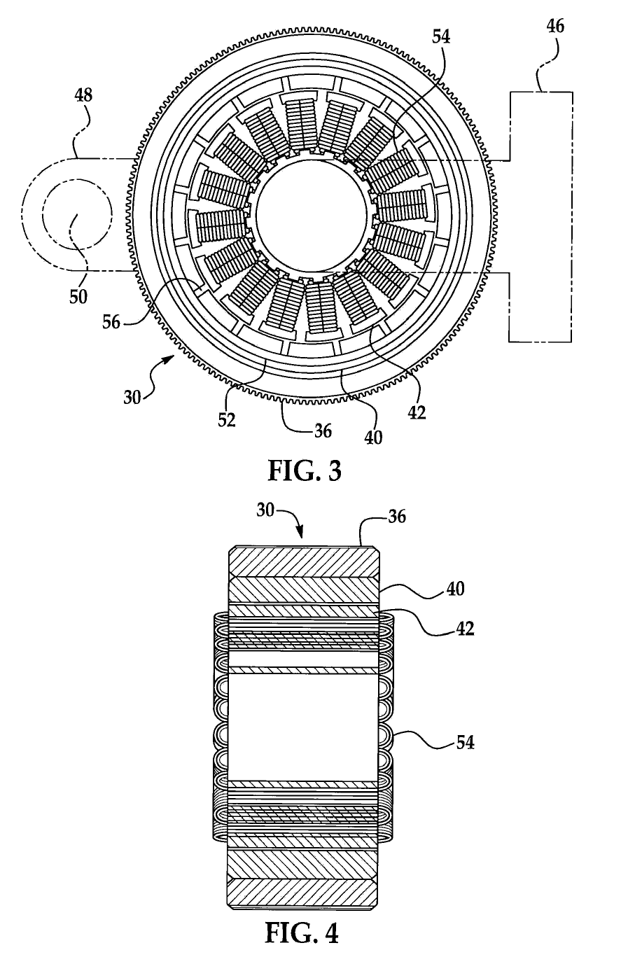

As shown in FIGS. 3 and 4, in a version of the exemplary embodiment, the drive member 36 takes the form of a harmonic drive that includes a wave generator 40. In particular, the harmonic drive is a gear of a gear train or set 36 having harmonic drive. However, it should be appreciated that the gearing can be other than harmonic. For example, the gear set 36 can be conventional (compound, planetary, simple, etc.). In any event, the gear set 36 acts as a speed-reduction device.

A reduction in number of components and, thereby, cost is achieved with design of the actuator 30. More specifically, placement of the motor 38 within the gear or gear set 36 removes the drive shaft and one set of bearings of the known actuator and reduces inertia and number of parts of the actuator 30. Also, the coupling and precision-machined housing of the known actuator are not required in the actuator 30 since an axis of rotation of the motor 38 is controlled by the gear set 36 itself.

“Reliability” analysis uses essentially a “reliability” factor for each component of a system multiplied by a number of components thereof. Thus, with fewer components of the same reliability with respect to each other, the system is more reliable. The actuator 30 has the fewest components for design of a motor/gear-set combination, leading to higher reliability of the actuator 30.

The motor 38 is electric and can take the form of a brushless motor having the rotor 52 and stator 42. The motor 38 is also frameless and of a high-performance type (i.e., has a high power-to-weight or power-to-volume ratio or power density). It should be appreciated that the motor 38 can be any suitable type of motor 38 that has a rotor 52 positioned on the outside.

The stator 42 is fixed and includes a plurality of coils 54. An exterior/outer surface 52 of the rotor 52 acts as the wave generator 40 of the harmonic drive 36. Alternatively, the wave generator 52 can be shaped to the exterior/outer surface. As shown in FIG. 3, an air gap 56 is defined between the rotor 52 and stator 42.

The actuator 30 is configured to be employed with a thin-wing aircraft. Toward that end, arrangement of the actuator 30 does not have inefficiencies associated with packaging and is optimized for typical requirements of such an actuator in flight-control applications—power density, performance, and reliability. More specifically, the concentric packaging of the harmonic drive 36 and motor 38 (stator 42 and rotor 52) of the actuator 30 provides a higher power density. Also, a load path of the actuator 30 is a direct drive such that a drive shaft is not required, resulting in a lower inertia and, in turn, higher performance. Furthermore, the actuator 30 has few components (including removal of one set of bearings and no requirement as well for the compliant coupling or precision-machined housing), which lends itself to higher reliability and reduced cost. In addition, a total stack length of the actuator 30 can be changed to accommodate a higher output load, making the actuator 30 versatile for different applications. Moreover, the actuator 30 can achieve higher forces while it maintains a same cross-section thereof, making the actuator 30 versatile for the different applications.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various non-limiting embodiments of the invention have been described, it is to be understood that aspects of the invention may include only some of the described embodiments. Accordingly, the invention is not to be seen as limited by the foregoing description, but is only limited by the scope of the appended claims.

1. An electromechanical hinge-line rotary actuator comprising:
a drive member; and
a motor disposed inside and directly coupled to the drive member and including a rotor configured toward an outside of the motor and directly coupled to an input of the drive member and a stator configured toward an inside of the motor and positioned inside the rotor, the drive member, rotor, and stator being arranged concentrically with each other.

2. The electromechanical hinge-line rotary actuator of claim 1, wherein the actuator comprises further at least one ground arm configured to be connected to a spar of a wing of an aircraft.

3. The electromechanical hinge-line rotary actuator of claim 1, wherein the actuator comprises further an output arm extending from the drive member and configured to receive a pin for connection of the actuator to an output-control surface of an aircraft.

4. The electromechanical hinge-line rotary actuator of claim 1, wherein the drive member is a harmonic drive including a wave generator.

5. The electromechanical hinge-line rotary actuator of claim 4, wherein the drive member is any of a harmonic gear and compound, planetary, and simple conventional gear.

6. The electromechanical hinge-line rotary actuator of claim 1, wherein the motor is frameless and of a high-performance type.

7. The electromechanical hinge-line rotary actuator of claim 4, wherein an exterior surface of the rotor acts as the wave generator of the harmonic drive or the wave generator is shaped to the exterior surface.

8. A wing of an aircraft comprising:
an aileron portion defining an axis of rotation and including an aileron spar;
a wing spar; and
a control system including an electromechanical hinge-line rotary actuator and a controller operatively linked to the actuator and a control system arranged within the aircraft; the actuator including:
a drive member; and
a motor disposed inside and directly coupled to the drive member and including a rotor configured toward an outside of the motor and directly coupled to an input of the drive member and a stator configured toward an inside of the motor and positioned inside the rotor, the drive member, rotor, and stator being arranged concentrically with each other.

9. The wing of claim 8, wherein the actuator comprises further at least one ground arm that is configured to be connected to the wing spar.

10. The wing of claim 9, wherein the actuator comprises further an output arm that extends from the drive member and is configured to receive a pin for connection of the actuator to an output-control surface of the aircraft.

11. The wing of claim 8, wherein the drive member is a harmonic drive including a wave generator.

12. The wing of claim 11, wherein the drive member is any of a harmonic gear and compound, planetary, and simple conventional gear.

13. The wing of claim 8, wherein the motor is frameless and of a high-performance type.

14. The wing of claim 11, wherein an exterior surface of the rotor acts as the wave generator of the harmonic drive or the wave generator is shaped to the exterior surface.

15. The wing of claim 10, wherein an axis of rotation of the output-control surface of the aircraft is aligned with an axis of rotation of the actuator.
